(19) United States
(12) Patent Application Publication
(10) Pub. No.: US 2004/0252101 A1
(43) Pub. Date: Dec. 16, 2004

(54) Input device that detects user's proximity

(75) Inventor: Tomasz F. Wilk, Cary, NC (US)

Correspondence Address: SAWYER LAW GROUP LLP, PO BOX 51418, PALO ALTO, CA, 94303, US

(73) Assignee: International Business Machines Corporation, Armonk, NY

(21) Appl. No.: 10/460,133

(22) Filed: Jun. 12, 2003

(51) Int. Cl. G09G 5/00

(52) U.S. Cl. 345/156

(57) ABSTRACT

A method for controlling a display device includes: determining if a user is proximate to an input device; and disabling at least a portion of the display device, if the user is not proximate to the input device. In one aspect, the input device includes a sensing element capable of sensing whether or not a user's hand is proximate to the input device. When the input device senses that a user's hand is proximate to the input device, then the graphic corresponding to the input device is displayed. When the input device senses that a user's hand is not proximate to the input device, then the graphic is hidden. In this manner, the display of a graphic corresponding to an input device is controlled such that the graphic does not obstruct the user's view when the user's hand is not proximate to the input device.

### FIELD OF THE INVENTION

The present invention relates to input devices for computing devices, and more particularly to the control of display devices based upon a user's proximity to the input devices.

### BACKGROUND OF THE INVENTION

The display on a display device of a graphic corresponding to an input device, such as a pointer for a mouse, on a display device is well known in the art. Often, a user removes his/her hand from the mouse to use the keyboard or for some other reason. The pointer, however, will continue to be displayed and may obscure the user's view. For example, the user may be filling out a form on a website. The user uses the mouse to select a text box, then moves the hand to the keyboard to enter text into the text box. Very often, the mouse pointer continues to be displayed over the text box, obscuring the view and making the reading of the typed text difficult.

Some software applications attempt to solve this problem by hiding the mouse pointer on the display device when the user starts to type using the keyboard. However, this approach relies on the software developer to provide this feature, and thus is not universally available for all applications the user may utilize. In addition, this approach does not solve the problem when the user removes the hand from the mouse but does not type using the keyboard, such as when the user is viewing text or graphics on the display device.

In a second example, some mouse pointers, such as the TrackPoint™, have been known to continue to move even after the user has stopped pushing on the TrackPoint™. This raises the annoyance factor for the user.

In a third example, displays for devices such as cellular phones often remain enabled even when a user is not using the device, such as when the user puts the phone down. This unnecessarily drains the battery of the device.

Accordingly, there exists a need for an improved method and system for controlling a display device based upon a user's proximity to an input device. The method and system should disable at least a portion of the display and/or the input device when the user is not proximate. The present invention addresses such a need.

### SUMMARY OF THE INVENTION

A method for controlling a display device includes: determining if a user is proximate to an input device; and disabling at least a portion of the display device, if the user is not proximate to the input device. In one aspect, the input device includes a sensing element capable of sensing whether or not a user's hand is proximate to the input device. When the input device senses that a user's hand is proximate to the input device, then the graphic corresponding to the input device is displayed. When the input device senses that a user's hand is not proximate to the input device, then the graphic is hidden. In this manner, the display of a graphic corresponding to an input device is controlled such that the graphic does not obstruct the user's view when the user's hand is not proximate to the input device.

### BRIEF DESCRIPTION OF THE FIGURES

FIG. 1 illustrates a preferred embodiment of a system for controlling a display device based upon a user's proximity to an input device in accordance with the present invention.

FIG. 2 is a flowchart illustrating a preferred embodiment of a method for controlling a display device based upon a user's proximity to an input device in accordance with the present invention.

FIG. 3 illustrates an example of an input device in accordance with the present invention.

FIGS. 4A and 4B illustrate a top view and a cross-sectional side view of details of the mouse in accordance with the present invention.

FIG. 5 is a flowchart illustrating an example implementation of the method for the mouse example in accordance with the present invention.

FIGS. 6A and 6B illustrate a top view and a cross-sectional side view of a second example input device in accordance with the present invention.

### DETAILED DESCRIPTION

The present invention provides an improved method and system for controlling a display device based upon a user's proximity to an input device. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

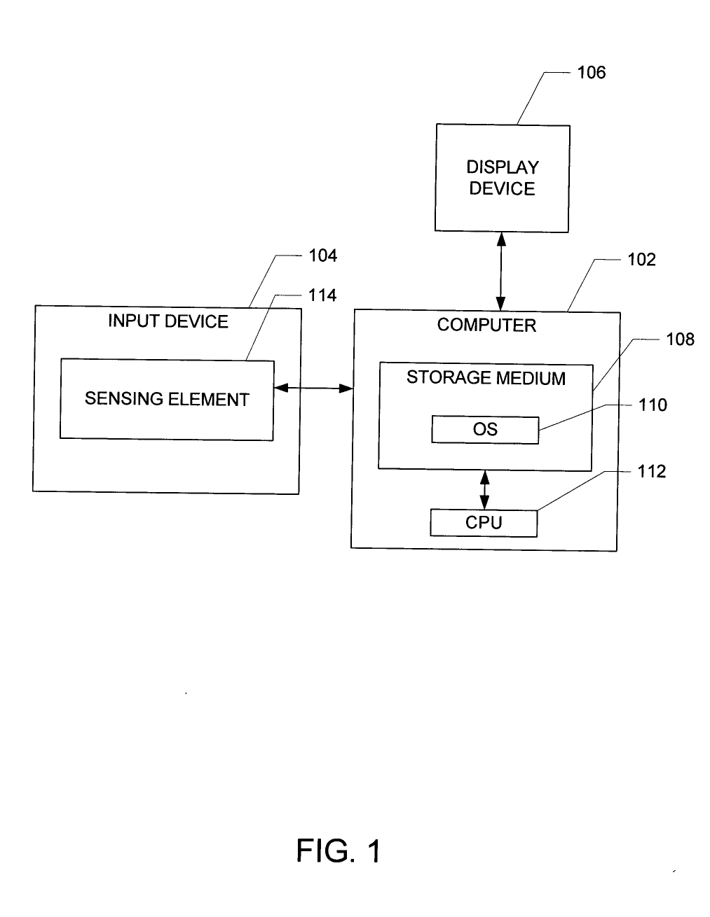

To more particularly describe the features of the present invention, please refer to FIGS. 1 through 6B in conjunction with the discussion below.

FIG. 1 illustrates a preferred embodiment of a system for controlling a display device based upon a user's proximity to an input device in accordance with the present invention. The system comprises a computer 102. Coupled to the computer 102 is an input device 104 and a display 106. The computer 102 can be a desktop computer, a laptop, a wearable computer, a personal digital assistance (PDA), a cellular phone, or any other type of computing device. The input device 104 can be a mouse, a keyboard, or any other input device that requires the proximity of a user's hand for input.

The computer 102 comprises a storage medium 108 for storing software, such as an operating system (OS) 110, and a central processing unit (CPU) 112. The input device 104 comprises a sensing element 114 that is capable of sensing whether or not a user's hand is proximate to the input device 104.

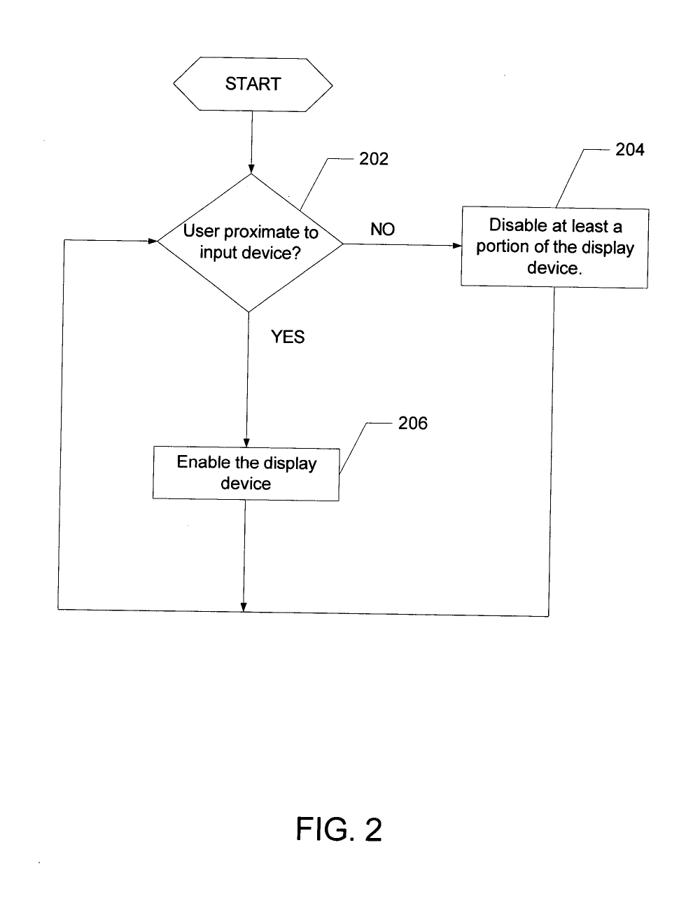

FIG. 2 is a flowchart illustrating a preferred embodiment of a method for controlling a display device based upon a user's proximity to an input device in accordance with the present invention. First, it is determined if the user is proximate to the input device 104, via step 202. For example, the sensing element 114 can be used to determine whether or not a user's hand is proximate to the input device 104. If the user's hand is proximate to the input device 104, then the display device 106 is enabled, via step 206. For example, if the input device 104 is a mouse and the user's hand is on the mouse, then the computer 102, through the OS 110, enables the display of a mouse pointer on the display device 106.For another example, if the input device is a set of keys for a cellular phone and the user is holding the phone, then the phone enables its display. Alternatively, the keys are enabled as well, allowing the user to use the phone.

If the user is not proximate to the input device 104, then at least a portion of the display device 106 is disabled, via step 204. For example, if the input device 104 is a mouse and the user's hand is not on the mouse, then the computer 102, through the OS 110, disables or hides the display of the mouse pointer on the display device 106. For another example, if the input device is a set of keys for a cellular phone and the user is not holding the phone, then the phone disables its display, reserving the phone's battery charge. Alternatively, the keys are disabled as well.

In this manner, a display device is controlled based upon a user's proximity to the input device.

Also, the detection of the user's hand can be used to avoid the accidental switching from “standby” to “on” state of the computer 102 due to movement of the input device. Typically, a computer 102 can be switched to the “on” state by moving the input device, such as a mouse or keyboard. However, if the input device is accidentally bumped or moved, the computer 102 may switch to the “on” state. This is avoided with the present invention, where the computer 102 can remain in the “standby” state until it is determined that the user's hand is proximate to the input device.

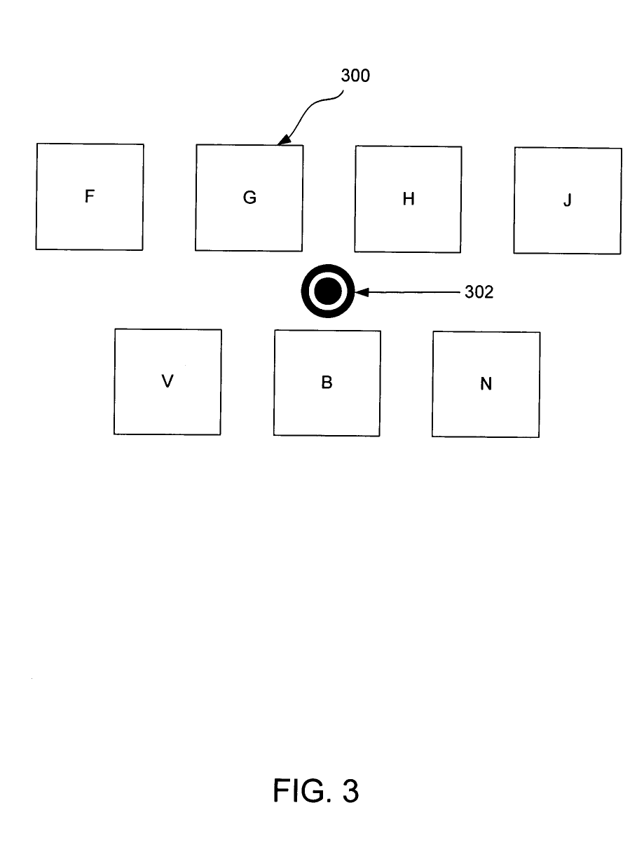

FIG. 3 illustrates an example of an input device in accordance with the present invention. In this example, the input device 104 is a TrackPoint™ mouse 302. The mouse 302 typically resides among the keys in a keyboard 300, as shown. As is known in the art, a user pushes the mouse 302 with a finger to direct the movement of a pointer displayed on the display device 106.

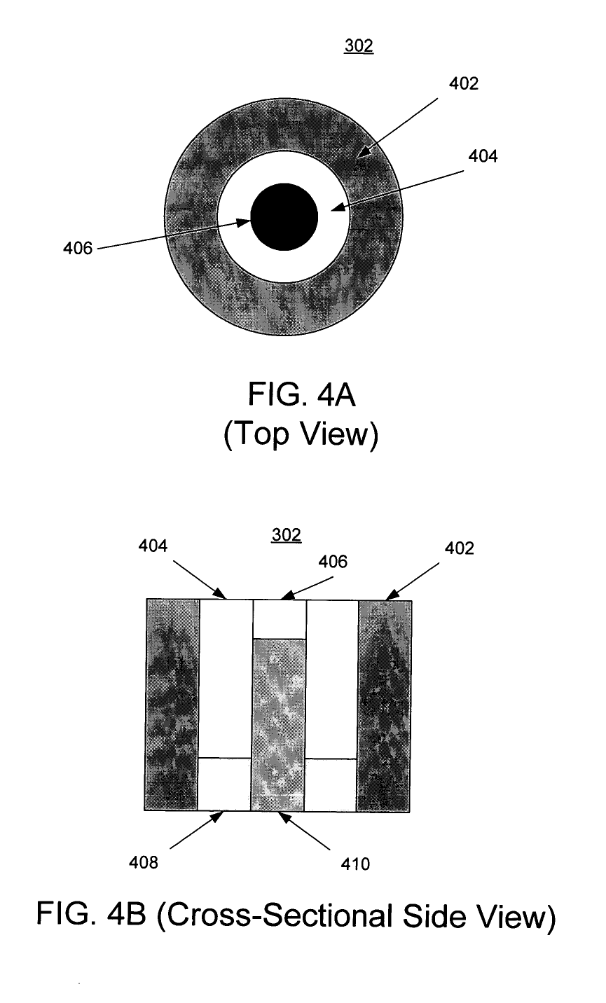

FIGS. 4A and 4B illustrate a top view and a cross-sectional side view of details of the mouse 302 in accordance with the present invention. The mouse 302 comprises a rubber foam outer layer 402, a glass or plaster middle layer 404, and a photosensitive inner layer 406. As illustrated in FIG. 4B, the middle layer 404 comprises a light emitting element 408, such as a light emitting diode (LED). The photosensitive inner layer 406 comprises a photosensitive element 410, such as a photodetector. Other types of light emitting and photosensitive elements may be used. The light emitting element 408 and the photosensitive element 410 comprise the sensing element 114.

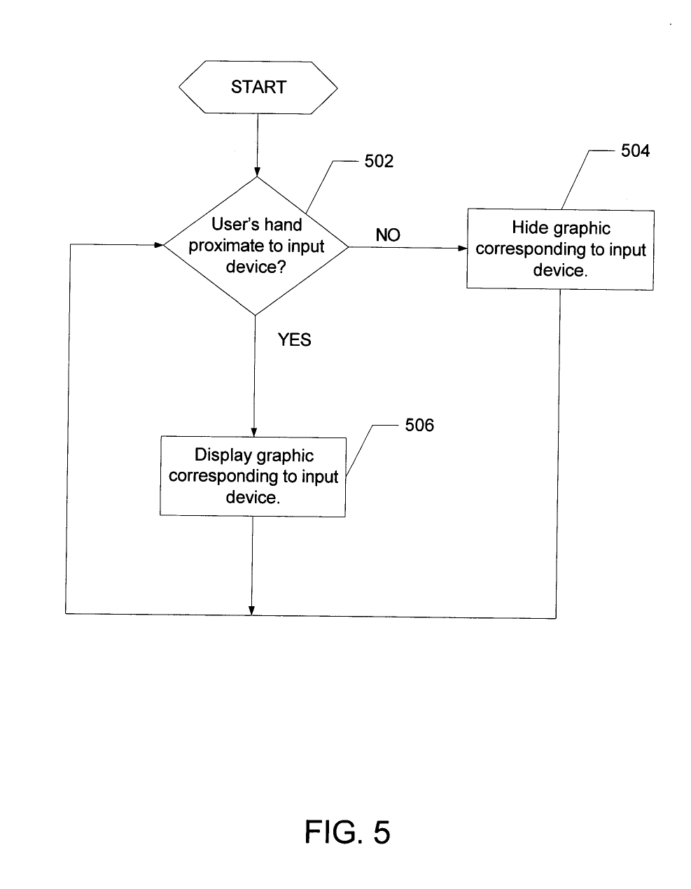

FIG. 5 is a flowchart illustrating an example implementation of the method for the mouse example in accordance with the present invention. As a user places a finger near or on the mouse 302, the light from the light emitting element 408 bounces off the finger onto the photosensitive element 410, triggering it. By monitoring the output of the photosensitive element 410, it is determined that a user's hand is proximate to the mouse 302, via step 502. The computer 102 then displays on the display device 106 the pointer corresponding to the mouse 302, via step 506.

As the user removes the finger from the proximity of the mouse 302, the light from the light emitting element 408 does not bounce off the finger onto the photosensitive element 410. By the absence of an output from the photosensitive element 410, it is determined that the user's hand is not proximate to the mouse 302, via step 502. The computer 102 then hides on the display device 106 the pointer corresponding to the mouse 302, via step 504.

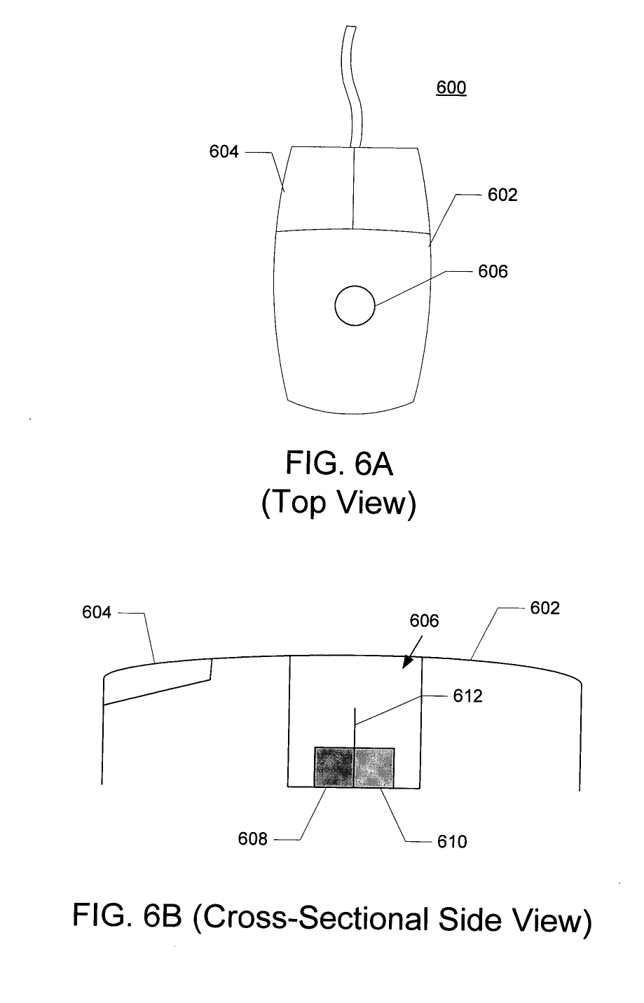

FIGS. 6A and 6B illustrate a top view and a cross-sectional side view of a second example input device in accordance with the present invention. The mouse 600 comprises a conventional mouse body 602, buttons 604, and a sensing element 606. As illustrated in FIG. 6B, the sensing element 606 comprises a light emitting element 608, such as an LED, and a photosensitive element 610, such as a photodetector. Other types of light emitting and photosensitive elements may be used. A divider 612 may be placed between the light emitting element 608 and the photosensitive element 610 to avoid accidental triggering of the photosensitive element 610.

Referring to FIGS. 5 and 6, as a user places a hand near or on the mouse 600, the light from the light emitting element 608 bounces off the hand onto the photosensitive element 610, triggering it. By monitoring the output of the photosensitive element 610, it is determined that a user's hand is proximate to the mouse 600, via step 502. The computer 102 then displays on the display device 106 the pointer corresponding to the mouse 600, via step 506.

As the user removes the hand from the proximity of the mouse 600, the light from the light emitting element 608 does not bounce off the hand onto the photosensitive element 610. By the absence of an output from the photosensitive element 610, it can be determined that the user's hand is not proximate to the mouse 600. The computer 102 then hides on the display device 106 the pointer corresponding to the mouse 600, via step 504.

Although the examples above are described with light emitting and photosensitive elements, one of ordinary skill in the art will understand that other means of sensing the proximity of a user's hand may be used without departing from the spirit and scope of the present invention. For example, capacitive or resistive sensing means may be used.

An improved method and system for controlling a display device based upon a user's proximity to an input device has been disclosed. The input device comprises a sensing element that is capable of sensing whether or not a user is proximate to the input device. When the input device senses that a user is proximate to the input device, then the display device is enabled. When the input device senses that a user is not proximate to the input device, then at least a portion of the display device is disabled. In this manner, the display device is controlled depending on whether or not a user is proximate to the input device.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for controlling a display device, comprising the steps of:
(a) determining if a user is proximate to an input device; and
(b) disabling at least a portion of the display device, if the user is not proximate to the input device.

2. The method of claim 1, further comprising:
(c) enabling the display device, if the user is proximate to the input device.

3. The method of claim 1, comprising:
(a1) determining if a user's hand is proximate to the input device; and
(b1) hiding a display on the display device of a graphic corresponding to the input device, if the user's hand is not proximate to the input device.

4. The method of claim 3, further comprising:
(c) displaying on the display device the graphic corresponding to the input device, if the user's hand is proximate to the input device.

5. The method of claim 3, wherein the determining step (a1) comprises:
(a1i) emitting a light from a light emitting element in the input device; and
(a1ii) determining if at least a portion of the light is detected by a photosensitive element in the input device, wherein the photosensitive element detects the at least a portion of the light if the user's hand is proximate to the input device.

6. The method of claim 5, wherein the light emitting element comprises a light emitting diode (LED).

7. The method of claim 5, wherein the photosensitive element comprises a photodetector.

8. The method of claim 3, wherein the input device comprises a mouse.

9. The method of claim 8, wherein the graphic comprises a mouse pointer.

10. The method of claim 1, further comprising:
(c) maintaining a standby state of a computer coupled to the input device, if the user is not proximate to the input device.

11. An input device, comprising:
a sensing element for sensing whether or not a user is proximate to the input device; and
an output of the sensing element, wherein the output indicates whether or not a user is proximate to the input device, wherein at least a portion of a display device is disabled if the user is not proximate to the input device.

12. The device of claim 11, wherein:
the sensing element senses whether or not a user's hand is proximate to the input device; and
the output of the sensing element indicates whether or not the user's hand is proximate to the input device, wherein a graphic corresponding to the input device is hidden on a display device if the user's hand is not proximate to the input device.

13. The device of claim 12, wherein the sensing element comprises:
a light emitting element; and
a photosensitive element.

14. The device of claim 13, wherein the light emitting element comprises a light emitting diode (LED).

15. The device of claim 13, wherein the photosensitive element comprises a photodetector.

16. The device of claim 12, wherein the input device comprises a mouse.

17. The device of claim 16, wherein the graphic comprises a mouse pointer.

18. The device of claim 12, wherein the graphic corresponding to the input device is displayed on the display device if the user's hand is proximate to the input device.

19. A system, comprising:
a computer;
a display device coupled to the computer; and
an input device coupled to the computer, wherein the input device comprises:
a sensing element for sensing whether or not a user is proximate to the input device, and
an output of the sensing element, wherein the output indicates whether or not a user is proximate to the input device, wherein at least a portion of the display device is disabled if the user is not proximate to the input device.

20. The system of claim 19, wherein the input device comprises:
the sensing element for sensing whether or not a user's hand is proximate to the input device; and
the output of the sensing element, wherein the output indicates whether or not the user's hand is proximate to the input device, wherein a graphic corresponding to the input device is hidden on the display device if the user's hand is not proximate to the input device.

21. The system of claim 20, wherein the sensing element comprises:
a light emitting element; and
a photosensitive element.

22. The system of claim 21, wherein the light emitting element comprises a light emitting diode (LED).

23. The system of claim 21, wherein the photosensitive element comprises a photodetector.

24. The system of claim 20, wherein the input device comprises a mouse.

25. The system of claim 24, wherein the graphic comprises a mouse pointer.

26. The system of claim 20, wherein the graphic corresponding to the input device is displayed on the display device if the user's hand is proximate to the input device.

27. The system of claim 20, wherein the computer is maintained in a standby state if the user's hand is not proximate to the input device.

28. A computer readable medium with program instructions for controlling a display device, comprising the instructions for:
(a) determining if a user is proximate to an input device; and
(b) disabling at least a portion of the display device, if the user is not proximate to the input device.

29. The medium of claim 28, further comprising the instructions for:
(c) enabling the display device, if the user is proximate to the input device.

30. The medium of claim 28, comprising the instructions for:
(a1) determining if a user's hand is proximate to the input device; and
(b1) hiding a display on the display device of a graphic corresponding to the input device, if the user's hand is not proximate to the input device.

31. The medium of claim 30, further comprising the instructions for:
(c) displaying on the display device the graphic corresponding to the input device, if the user's hand is proximate to the input device.

32. The medium of claim 30, wherein the determining instruction (a1) comprises instructions for:
(a1i) emitting a light from a light emitting element in the input device; and
(a1ii) determining if at least a portion of the light is detected by a photosensitive element in the input device, wherein the photosensitive element detects the at least a portion of the light if the user's hand is proximate to the input device.

33. The medium of claim 32, wherein the light emitting element comprises a light emitting diode (LED).

34. The medium of claim 32, wherein the photosensitive element comprises a photodetector.

35. The medium of claim 30, wherein the input device comprises a mouse.

36. The medium of claim 35, wherein the graphic comprises a mouse pointer.

37. The medium of claim 30, further comprising the instructions for:
(c) maintaining a standby state of a computer coupled to the input device, if the user's hand is not proximate to the input device.
